(19) United States
(12) Patent Application Publication
(10) Pub. No.: US 2026/0127751 A1
(43) Pub. Date: May 7, 2026

(54) Systems and Methods for Performing Optical Flow Using GPU Tensor Processing Cores

(71) Applicant: California Institute of Technology, Pasadena, CA (US)

(72) Inventors: Samuel H. Foxman, West Hartford, CT (US); Scott A. Bollt, Pasadena, CA (US); Morteza Gharib, Pasadena, CA (US)

(73) Assignee: California Institute of Technology, Pasadena, CA (US)

(21) Appl. No.: 19/378,158

(22) Filed: Nov. 3, 2025

Related U.S. Application Data
(60) Provisional application No. 63/715,303, filed on Nov. 1, 2024.
(60) Provisional application No. 63/823,578, filed on Jun. 13, 2025.

(51) Int. Cl. G06T 7/262; G06T 1/20; G06T 3/4084; G06T 7/246

(52) U.S. Cl. CPC G06T 7/262; G06T 1/20; G06T 3/4084; G06T 7/246; G06T 2207/10016; G06T 2207/20056

(57) ABSTRACT

The present disclosure relates to machine vision systems and methods for performing optical flow calculations. Machine vision systems in accordance with many embodiments of the invention use GPU tensor processing cores to perform one-dimensional Discrete Fourier Transform (DFT) calculations using real DFT matrices, enabling efficient separable window correlation for optical flow. In one embodiment, the machine vision system includes: a camera; a processor; a processor comprising tensor processing cores; and a memory containing instructions. Executing the instructions using the processors causes the machine vision system to: obtain a pair of sequential images from the camera; identify windows in the images; perform optical flow calculations using separable window correlation, wherein the separable window correlation calculations comprise performing one-dimensional discrete Fourier transform (DFT) calculations using the tensor processing cores, and wherein the one-dimensional DFT calculations are performed on the tensor processing cores using real DFT matrices; and output optical flow information.

### CROSS-REFERENCE TO RELATED APPLICATIONS

The current application claims priority under 35 U.S.C. 119 (e) to U.S. Provisional Patent Application Ser. No. 63/715,303, entitled “Portable Real-Time Optical Flow-Field Sensor”, filed Nov. 1, 2024 and U.S. Provisional Patent Application Ser. No. 63/823,578, entitled “Systems and Methods for Performing Optical Flow Using GPU Tensor Processing Cores”, filed Jun. 13, 2025. The disclosures of U.S. Provisional Patent Application Ser. No. 63/715,303 and U.S. Provisional Patent Application Ser. No. 63/823,578 of which is incorporated herein by reference in their entirety.

### FIELD OF INVENTION

The present disclosure relates to machine vision systems and methods, and more particularly to systems and methods for performing optical flow calculations using tensor processing cores within graphics processing units (GPUs).

### BACKGROUND

Optical flow is a computer vision technique that estimates the motion of objects, surfaces, and edges between consecutive frames in a video sequence. Optical flow processes can calculate the apparent movement of pixels or features from one image to the next, providing valuable information about the dynamics of a scene.

Optical flow processes can have numerous applications across various fields. In computer vision and robotics, optical flow processes can aid in tasks such as motion detection, object tracking, and navigation. For video compression algorithms, optical flow processes can enable efficient encoding by predicting frame-to-frame changes. In autonomous vehicles, optical flow processes can contribute to obstacle avoidance and path planning. Medical imaging applications can also utilize optical flow for analyzing organ movements and blood flow.

Implementing optical flow algorithms on Graphics Processing Units (GPUs) has become increasingly common due to the parallel processing capabilities of these specialized hardware components. GPUs are designed to handle multiple computations simultaneously, making them well-suited for the pixel-level operations involved in optical flow calculations. Adapting optical flow algorithms for GPU architectures typically involves restructuring the computations to exploit parallel processing and optimize memory access patterns.

GPU-based optical flow implementations can offer advantages such as improved processing speed and the ability to handle larger datasets. However, challenges exist in efficiently utilizing GPU resources, managing memory bandwidth, and balancing workload distribution across processing units. Additionally, achieving high accuracy while maintaining real-time performance remains an ongoing area of research and development.

The architectures of GPUs typically differ from those of Central Processing Units (CPUs) in several ways. GPUs typically contain a large number of smaller, more specialized processing cores optimized for performing many calculations in parallel. This design can allow GPUs to execute certain types of algorithms faster than conventional CPUs, particularly those involving matrix operations and floating-point arithmetic.

The parallel processing capabilities of GPUs can make them particularly effective for tasks that can be broken down into many independent calculations. Image processing, including optical flow computations, often falls into this category as operations can be performed on multiple pixels or regions simultaneously. This parallelism enables GPUs to achieve significant speedups compared to sequential processing on CPUs for many computer vision and image analysis tasks.

Recent advancements in GPU technology have introduced tensor processing cores, which are specialized hardware units designed to accelerate specific types of mathematical operations commonly used in machine learning and scientific computing. Tensor cores are optimized for matrix multiplication and accumulation operations, which form the basis of many deep learning algorithms and other computationally intensive tasks.

Tensor processing cores achieve computational efficiencies through several mechanisms. They operate on lower precision data types, such as 16-bit floating-point numbers, which allows for faster calculations and reduced memory bandwidth usage. Tensor cores also employ specialized matrix multiply-accumulate operations to perform multiple fused multiply-add computations. This hardware-level optimization enables tensor cores to achieve significantly higher throughput for certain types of calculations compared to traditional GPU cores.

### SUMMARY

Systems and methods in accordance with various embodiments of the invention accelerate optical flow calculations by leveraging tensor processing cores within graphics processing units (GPUs). This approach can enable significant performance improvements in terms of throughput and latency compared to traditional implementations. The acceleration of optical flow calculations can enhance real-time processing capabilities for high-resolution image streams, potentially benefiting applications such as, but not limited to, autonomous vehicles, robotics, and video compression.

While tensor processing cores in GPUs are primarily designed for performing calculations in neural networks, their architectural characteristics can be utilized to perform various transformations commonly utilized in machine vision systems. These transformations may include, but are not limited to, discrete Fourier transforms and discrete cosine transformations. The specialized matrix multiply-accumulate operations and optimized data handling of tensor cores may enable efficient execution of these transformations.

Utilizing tensor processing cores to perform these transformations may offer several benefits. The cores' ability to perform multiple scalar fused multiply-add computations in a single clock cycle may result in increased computational throughput. Additionally, the use of lower precision data types can reduce memory bandwidth usage, potentially improving overall system efficiency. The parallel processing capabilities of tensor cores can also allow for simultaneous transformation of multiple image regions, further accelerating machine vision tasks.

However, using tensor processing cores that can only process real values to perform transformations involving complex values can present challenges. Many image processing algorithms, including certain formulations of discrete Fourier transforms, involve complex number arithmetic. Machine vision systems and methods implemented in accordance with various embodiments of the invention rely upon the use of algorithms that are adapted to work with real-value-only tensor cores involves innovative mathematical reformulations and careful management of data representations. In some cases, this can involve separating real and imaginary components or using alternative representations of complex numbers that can be processed using real-value operations.

In one embodiment, a machine vision system is provided. The machine vision system includes a camera, a processor, a graphics processing unit (GPU) comprising tensor processing cores, and a memory containing instructions that, when executed by the processor, cause the machine vision system to: obtain a pair of sequential input images from the camera; identify windows in the input images; perform optical flow calculations using separable window correlation, wherein the separable window correlation calculations include performing one-dimensional Discrete Fourier Transform (DFT) calculations using the GPU tensor processing cores, and wherein the one-dimensional DFT calculations are performed on the GPU tensor processing cores using real Discrete Fourier Transform matrices; and output optical flow information for the input images.

In another embodiment, the instructions further cause the machine vision system to generate the real Discrete Fourier Transform matrices by: expanding a complex Discrete Fourier Transform matrix into an expanded matrix; removing redundant rows from the expanded matrix; and scaling DC and Nyquist rows of the resulting matrix.

In yet another embodiment, the real Discrete Fourier Transform matrix R is defined by:

$${R}_{r , c} := \{ \begin{matrix}\frac{\sqrt{2}}{2} & if r = 0 \\ \frac{\sqrt{2}}{2} cos ( π c ) & if r = 1 \\ cos ( {α}_{⌊ r / 2 ⌋} c ) & if r \geq 2 and r is even \\ sin ( {α}_{⌊ r / 2 ⌋} c ) & if r \geq 3 and r is odd\end{matrix}$$

where αₖ represents a frequency component associated with each row.

In a further embodiment, the instructions further cause the machine vision system to reconstruct complex Fourier space values for the 2D discrete Fourier transform from outputs of the real Discrete Fourier Transform matrices by: removing a DC×DC component; handling top-left corner values; processing top two rows and left two columns; and reconstructing remaining complex values using 2×2 submatrices.

In another embodiment, reconstructing the remaining complex values includes: for a 2×2 submatrix with top-left corner (u,v), calculating:

$${F}_{u / 2 , v / 2} = ( {S}_{u , v} - {S}_{u + 1 , v + 1} ) + i ( {S}_{u , v + 1} + {S}_{u + 1 , v} )$$

$${F}_{W - u / 2 , v / 2} = ( {S}_{u , v} + {S}_{u + 1 , v + 1} ) + i ( {S}_{u , v + 1} - {S}_{u + 1 , v} )$$

where F represents complex Fourier space values for the 2D discrete Fourier transform, S represents outputs of the real Discrete Fourier Transform matrices, and W is the window size.

In yet another embodiment, the instructions further cause the machine vision system to accelerate an ArgMax calculation by: bit-casting float16 values to int16 format; packing maximum values and their indices into single 32-bit integers; performing a warp-wide int32 max reduction; and extracting a maximum value and its index from the reduction result.

In a further embodiment, accelerating the ArgMax calculation further includes: comparing float16 values with zero and bit-casting the maximum to int16 format; left-shifting the bit-cast value by 16 bits and combining it with an index; applying a warp-wide int32 max function to the combined value; and extracting a maximum value and its index from the reduction result using bit masking and shifting operations.

In another embodiment, the instructions further cause the machine vision system to accelerate matrix transposition by: executing a nested loop structure in parallel across GPU threads; determining a permutation index for each value in a first matrix (C); and reassigning values to a matrix transpose (B^{T}) based on the determined permutation indices.

In yet another embodiment, determining the permutation index includes calculating:

$${L}_{{B}^{T}}^{- 1} ( {L}_{C} ( t , v ) )$$

where L_{C} and L_{B}_{^{T}} are layout functions that define how register indices map to positions in the full matrices C and B^{T}, respectively, t is a thread index, and vis a value index within the thread.

In a further embodiment, the windows in the input images is selected from the group consisting of: 16 pixels by 16 pixels; 32 pixels by 32 pixels; and 48 pixels by 48 pixels. As can readily be appreciated, any of a variety of window sizes can be utilized including (but not limited to) window sizes that involve overlap between windows.

In one embodiment, a method for performing optical flow in a machine vision system is provided. The method includes: obtaining a pair of sequential input images; identifying windows in the input images; performing optical flow calculations using separable window correlation, wherein the separable window correlation calculations include: obtaining one-dimensional discrete Fourier transforms (DFTs) of columns and rows of a window in a first image using a first real DFT matrix; obtaining one-dimensional DFTs of columns and rows of a corresponding window in a second image using a second real DFT matrix; reconstructing complex Fourier space values for the 2D discrete Fourier transform from outputs obtained using the real DFT matrices; performing elementwise multiply-conjugate operations with respect to the reconstructed complex Fourier space values; converting complex products to real values to obtain a real value matrix; obtaining one-dimensional inverse discrete Fourier transforms (IDFTs) of rows and columns of the real value matrix; and determining subpixel peaks based upon output of the one-dimensional IDFTs; and outputting optical flow information for the input images.

In another embodiment, obtaining the one-dimensional discrete Fourier transforms of columns and rows of a window in the first image using the corresponding firstreal DFT matrix includes: expanding a complex Discrete Fourier Transform matrix into an expanded matrix; removing redundant rows from the expanded matrix; and scaling DC and Nyquist rows of the resulting matrix to generate the real DFT matrix.

In yet another embodiment, the first real DFT matrix R is defined by:

$${R}_{r , c} := \{ \begin{matrix}\frac{\sqrt{2}}{2} & if r = 0 \\ \frac{\sqrt{2}}{2} cos ( π c ) & if r = 1 \\ cos ( {α}_{⌊ r / 2 ⌋} c ) & if r \geq 2 and r is even \\ sin ( {α}_{⌊ r / 2 ⌋} c ) & if r \geq 3 and r is odd\end{matrix}$$

where αₖ represents the frequency component associated with each row.

In a further embodiment, reconstructing complex Fourier space values for the 2D discrete Fourier transform from outputs obtained using the first real DFT matrix includes: removing a DC×DC component; handling top-left corner values; processing top two rows and left two columns; and reconstructing remaining complex values using 2×2 submatrices.

In another embodiment, reconstructing the remaining complex values includes: for a 2×2 submatrix with top-left corner (u,v), calculating:

$${F}_{u / 2 , v / 2} = ( {S}_{u , v} - {S}_{u + 1 , v + 1} ) + i ( {S}_{u , v + 1} + {S}_{u + 1 , v} )$$

$${F}_{W - u / 2 , v / 2} = ( {S}_{u , v} + {S}_{u + 1 , v + 1} ) + i ( {S}_{u , v + 1} - {S}_{u + 1 , v} )$$

where F represents complex Fourier space values for the 2D discrete Fourier transform, S represents outputs of the real Discrete Fourier Transform matrices, and W is the window size.

In yet another embodiment, the method further includes accelerating ArgMax calculation by: bit-casting float16 values to int16 format; packing maximum values and their indices into single 32-bit integers; performing a warp-wide int32 max reduction; and extracting a maximum value and its index from the reduction result.

In a further embodiment, accelerating the ArgMax calculation further includes: comparing float16 values with zero and bit-casting the maximum to int16 format; left-shifting the bit-cast value by 16 bits and combining it with an index; applying a warp-wide int32 max function to the combined value; and extracting a maximum value and its index from the reduction result using bit masking and shifting operations.

In another embodiment, the method further includes accelerating matrix transposition by: executing a nested loop structure in parallel across GPU threads; determining a permutation index for each value in a first matrix (C); and reassigning values to a matrix transpose (B^{T}) based on the determined permutation indices.

In yet another embodiment, determining the permutation index includes calculating:

$${L}_{{B}^{T}}^{- 1} ( {L}_{C} ( t , v ) )$$

where L_{C} and L_{B}_{^{T}} are layout functions that define how register indices map to positions in the full matrices C and B transpose, respectively, t is a thread index, and v is a value index within the thread.

In a further embodiment, the windows in the input images is selected from the group consisting of: 16 pixels by 16 pixels; 32 pixels by 32 pixels; and 48 pixels by 48 pixels. As can readily be appreciated, any of a variety of window sizes can be utilized including (but not limited to) window sizes that involve overlap between windows.

The foregoing general description of the illustrative embodiments and the following detailed description thereof are merely exemplary aspects of the teachings of this disclosure and are not restrictive.

In a further embodiment, a portable optical flow measurement system is provided. The portable optical flow measurement system includes a housing configured for handheld operation, a laser disposed within the housing and configured to generate a light beam, a beamshaping optic operatively coupled to the laser and configured to shape the light beam into a sheet of light for illuminating particles within a measurement plane, a first camera disposed within the housing and configured to capture images of the illuminated particles, a second camera disposed within the housing and arranged in a stereographic configuration with the first camera to capture images from a different perspective, a chromatic filter positioned in front of the first camera and the second camera, a processor operatively coupled to the first camera and the second camera, a graphics processing unit (GPU) comprising tensor processing cores and operatively coupled to the processor, and a memory containing instructions that, when executed by the processor, cause the portable optical flow measurement system to obtain sequential input images from the first camera and the second camera, identify windows in the input images, perform optical flow calculations using separable window correlation, wherein the separable window correlation calculations comprise performing one-dimensional Discrete Fourier Transform (DFT) calculations using the GPU tensor processing cores, and wherein the one-dimensional DFT calculations are performed on the GPU tensor processing cores using real Discrete Fourier Transform matrices, and output optical flow information for three-dimensional velocity reconstruction within the measurement plane.

In another embodiment, the first camera and the second camera each comprise a Scheimpflug lens configured to enable focusing across the measurement plane when the cameras are positioned at acute viewing angles.

In yet another embodiment, the instructions further cause the portable optical flow measurement system to generate the real Discrete Fourier Transform matrices by expanding a complex Discrete Fourier Transform matrix into an expanded matrix, removing redundant rows from the expanded matrix, and scaling DC and Nyquist rows of the resulting matrix.

In a further embodiment, the instructions further cause the portable optical flow measurement system to reconstruct complex Fourier space values for the 2D discrete Fourier transform from outputs of the real Discrete Fourier Transform matrices by removing a DC×DC component, handling top-left corner values, processing top two rows and left two columns, and reconstructing remaining complex values using 2×2 submatrices.

In another embodiment, the instructions further cause the portable optical flow measurement system to accelerate an ArgMax calculation by bit-casting float16 values to int16 format, packing maximum values and their indices into single 32-bit integers, performing a warp-wide int32 max reduction, and extracting a maximum value and its index from the reduction result.

In yet another embodiment, the instructions further cause the portable optical flow measurement system to accelerate matrix transposition by executing a nested loop structure in parallel across GPU threads, determining a permutation index for each value in a first matrix, and reassigning values to a matrix transpose based on the determined permutation indices.

In a further embodiment, the housing comprises a rectangular body portion mounted on a stem structure.

In another embodiment, the windows in the input images are 32 pixels by 32 pixels.

### BRIEF DESCRIPTION OF FIGURES

The patent or application file contains at least one drawing executed in color. Copies of this patent or patent application publication with color drawing(s) will be provided by the Office upon request and payment of the necessary fee.

The description and claims will be more fully understood with reference to the following figures and data graphs, which are presented as exemplary embodiments of the invention and should not be construed as a complete recitation of the scope of the invention.

FIG. 1 illustrates use of a machine vision system to perform optical flow measurements of a dynamic scene in accordance with an embodiment of the invention.

FIG. 2A and FIG. 2B illustrate how optical flow is calculated between two sequential images.

FIG. 3 illustrates a block diagram of a machine vision processing system in accordance with an embodiment of the invention.

FIG. 4 illustrates a flowchart for determining optical flow from a pair of sequential input images using separable window correlation in accordance with an embodiment of the invention.

FIG. 5 illustrates how an image can be divided into multiple windows in accordance with an embodiment of the invention.

FIG. 6 illustrates a flowchart for performing separable window correlation using GPU tensor processing cores in accordance with an embodiment of the invention.

FIG. 7 illustrates a series of operations for performing window correlation using real discrete Fourier transform operations in accordance with an embodiment of the invention.

FIGS. 8A-8C illustrate a system for generating a real discrete Fourier transform matrix in accordance with an embodiment of the invention.

FIG. 9 illustrates operations performed to transform outputs obtained using real discrete Fourier transform matrices to complex Fourier space in accordance with an embodiment of the invention.

FIG. 10 illustrates a visual representation of four cases for reconstructing complex Fourier space values for the 2D discrete Fourier transform in accordance with an embodiment of the invention.

FIG. 11 illustrates operations performed to accelerate ArgMax calculation using GPU tensor processing cores in accordance with an embodiment of the invention.

FIG. 12 illustrates operations performed to perform matrix transposition via register reassignment in accordance with an embodiment of the invention.

FIG. 13 illustrates performance comparison charts showing throughput, latency, and GPU power consumption metrics in accordance with an embodiment of the invention.

FIG. 14A is a perspective view of a hand-held optical flow measurement system in accordance with an embodiment of the invention.

FIG. 14B is an alternative perspective view of the hand-held optical flow measurement system.

FIG. 14C is a cross-sectional view of the hand-held optical flow measurement system showing internal optical components.

### DETAILED DESCRIPTION

Turning now to the drawings, machine vision systems and methods in accordance with various embodiments of the invention utilize an efficient formulation of one-dimensional Discrete Fourier Transforms (DFTs) that enables computation using GPU tensor processing cores. This new formulation can lead to significant performance improvements for optical flow calculations. In several embodiments, the processes described herein can be utilized to perform Real-Time Particle Imaging Velocimetry (RTPIV). In a number of embodiments, RTPIV can be performed using portable and/or hand-held devices that incorporate a laser with optics to shape the laser output into a sheet of light and multiple cameras configured in a stereographic configuration.

In some embodiments, the one-dimensional DFTs are implemented using real-valued discrete Fourier transform matrices. The use of real-valued matrices allows the computations to leverage the matrix multiplication capabilities of GPU tensor processing cores, which are optimized for real-value operations. This approach can provide substantial speedups compared to traditional complex-valued DFT implementations.

In a number of embodiments, the optical flow process also includes the use of register-only matrix transposition and/or accelerated ArgMax calculations. These optimizations can further enhance the efficiency of optical flow computations on GPU architectures that incorporate tensor processing cores. By utilizing these techniques, optical flow calculations can be performed with lower latency and higher throughput compared to previous methods.

Machine vision systems and processes for performing optical flow calculations using tensor processing cores within GPUs in accordance with various embodiments of the invention are discussed further below.

### Optical Flow Processes

Optical flow is a fundamental concept in computer vision that measures the apparent motion of objects between consecutive frames of video or sequential images. Optical flow calculations can be useful in a variety of machine vision applications, including (but not limited to) depth estimation, object tracking, motion estimation, and video compression. The ability to accurately and efficiently compute optical flow can be crucial for real-time performance in many applications.

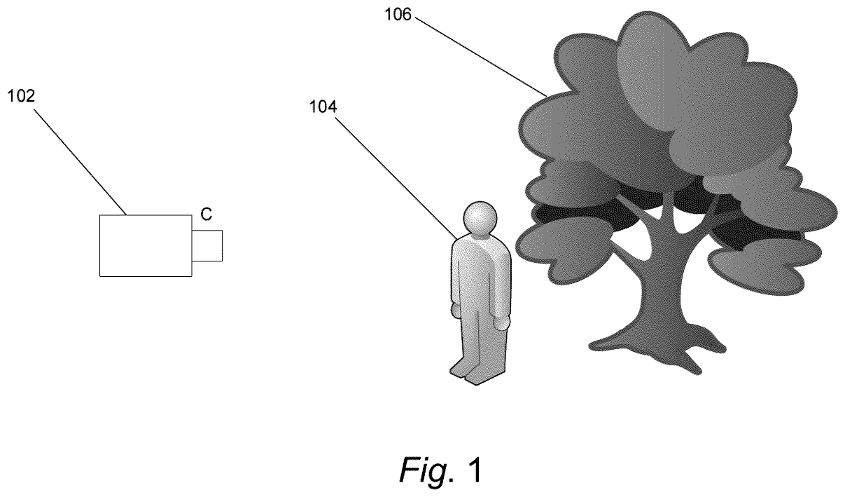

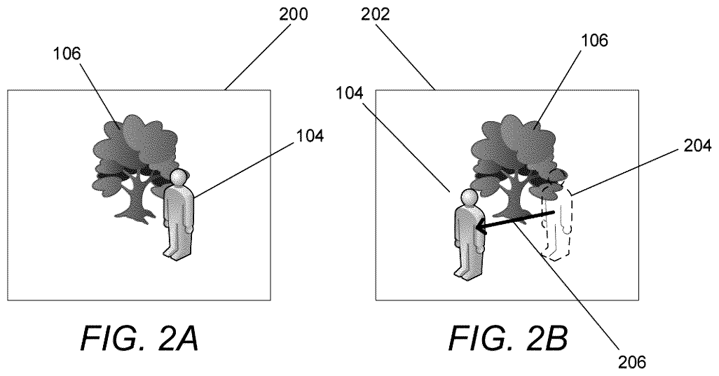

Use of a machine vision system to perform optical flow measurements of a dynamic scene in accordance with an embodiment of the invention is conceptually illustrated in FIG. 1. The machine vision system 102 may capture images of a scene containing a person 104 and a tree 106. FIG. 2A and FIG. 2B illustrate how optical flow is calculated between two sequential images. FIG. 2A shows a first image 200 containing the person 104 standing next to the tree 106. FIG. 2B shows a second image 202 captured after the first image, where the person 104 has moved to a new position. A dashed outline 204 indicates the position occupied by the person in the first image. An arrow 206 represents the optical flow vector that quantifies the movement of the person between the two frames. Measuring the optical flow vector between the first image 200 and the second image 204 can enable the machine vision system to obtain information concerning motion within the scene that can be useful in applications including the various applications referenced above in which optical flow calculations are performed.

Machine Vision Systems Incorporating GPUs having Tensor Processing Cores

Machine vision systems may utilize specialized hardware to accelerate optical flow computations. Graphics Processing Units (GPUs) are particularly well-suited for this task due to their highly parallel architecture and ability to perform efficient matrix operations. The use of GPUs within machine vision systems can significantly improve the speed and efficiency of optical flow calculations.

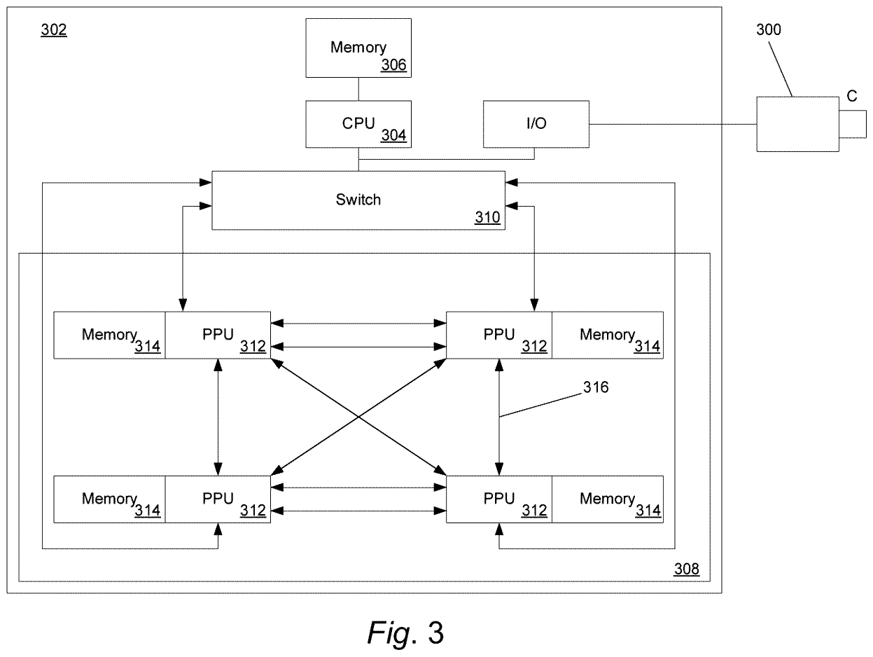

A machine vision processing system in accordance with an embodiment of the invention is illustrated in FIG. 3. The machine vision processing system 302 includes a camera 300 that connects to an application processor 304. The application processor 304 is coupled to main memory 306. A graphics processing unit (GPU) 308 connects to the application processor 304 via a switch 310. The GPU 308 contains multiple parallel processing units 312. Each parallel processing unit 312 connects to memory 314. The parallel processing units 312 are interconnected through a high speed interconnect 316. The switch 310 provides connectivity between the parallel processing units 312 and other components of the system. In the illustrated embodiment, each of the parallel processing units 312 contains at least one tensor processing core. As noted above, the tensor processing cores can be utilized to efficiently perform matrix multiplications, which can be leveraged to accelerate optical flow calculations.

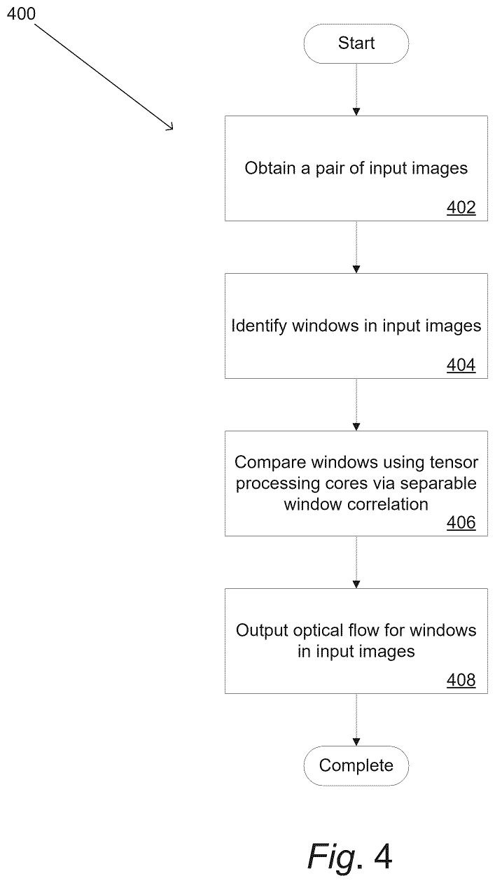

Although specific machine vision processing system architectures capable of performing optical flow are discussed above with reference to FIG. 3, as can readily be appreciated alternative architectures including machine vision processing systems that employ alternative GPU architectures and/or alternative parallel processing units can be utilized in machine vision systems as appropriate to the requirements of specific applications in accordance with various embodiments of the invention. Furthermore, the machine vision systems described above with respect to FIG. 3 can be used to perform any of the processes and/or operations discussed below. By way of example, any of the machine vision processing systems described above with respect to FIG. 3 can be used to perform any of the processes and/or operations described below with reference to FIGS. 4, 6, 8A-8C, 9, 11, and 12. Processes for performing optical flow using separable window correlation that leverage the tensor processing cores of GPUs in accordance with various embodiments of the invention are discussed further below.

### Optical Flow Processes Incorporating Separable Window Correlation

Optical flow processes implemented in accordance with certain embodiments of the invention perform separable window correlation. Separable window correlation can be particularly beneficial when performing optical flow on a GPU that includes tensor processing cores. This approach allows for efficient utilization of the GPU's parallel processing capabilities and can lead to significant performance improvements. While much of the discussion contained herein refers to GPUs that incorporate tensor processing cores, it should be appreciated that the systems and methods described herein are not limited to the use of GPUs. For example, tensor processing cores are also incorporated within a variety of processing device devices including (but not limited to) Tensor Processing Units and Neural Engines. Accordingly, it should be understood that any reference herein to a GPU is not limited to simply a GPU, but encompasses GPUs, TPUs, Neural Engines and/or any other type of processing device that incorporates at least one tensor processing core and/or any other circuitry incorporating a general matrix multiplication accelerator.

A process for determining optical flow from a pair of sequential input images in accordance with an embodiment of the invention is illustrated in FIG. 4. The process 400 begins with obtaining a pair of input images 402. After the input images are obtained, the process continues with identifying windows in the input images 404. The process then moves to comparing windows from the pair of sequential input images by performing separable window correlation using GPU tensor processing cores 406. Following the window comparison, the process concludes with outputting optical flow information for the input images 408.

As can readily be appreciated, the processes described above with reference to FIG. 4 can be performed using any of the machine vision processing systems described above with respect to FIG. 3. Furthermore, although a specific process for performing optical flow is discussed above with reference to FIG. 4, alternative processes that utilize separable window correlation can be performed as appropriate to the requirements of specific applications in accordance with various embodiments of the invention.

Optical flow processes implemented in accordance with many embodiments of the invention divide input images into windows that can be overlapping or non-overlapping. Using window sizes that correspond to the sizes of the registers in the underlying GPU tensor processing unit architecture can provide performance benefits by optimizing memory access and computation patterns.

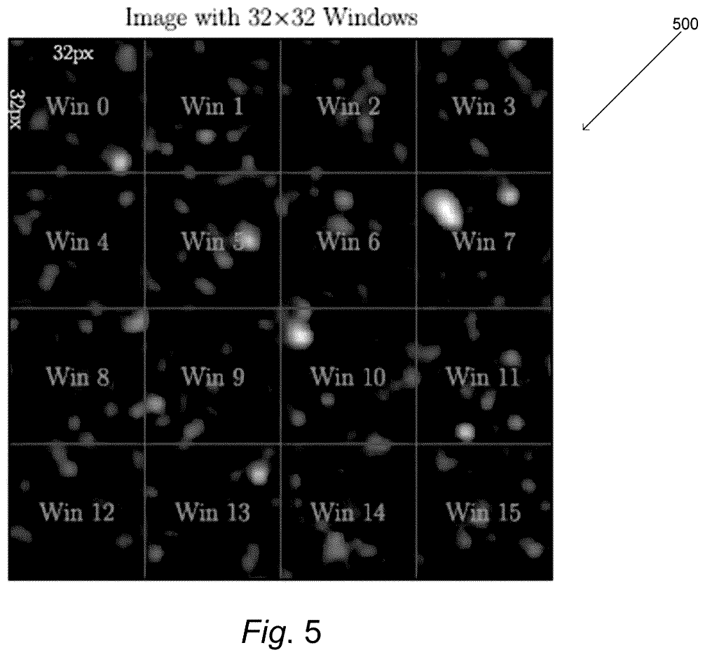

An image broken into windows of 32 pixel by 32 pixel windows defined with respect to an input image in accordance with an embodiment of the invention is illustrated in FIG. 5. The image is divided into a grid of square windows, with each window having dimensions of 32 pixels by 32 pixels. In the illustrated embodiment, the windows are arranged with no overlap between them.

Although a specific window size and arrangement are discussed above with reference to FIG. 5, alternative window sizes including (but not limited to) rectangular window sizes can be utilized and/or overlapping windows can be utilized to perform optical flow as appropriate to the requirements of specific applications in accordance with various embodiments of the invention.

Optical flow processes implemented in accordance with a number of embodiments of the invention utilize one dimensional discrete Fourier transforms using real DFT matrices that enable the one dimensional DFT computations to be performed on the tensor processing cores of a GPU. Using the tensor processing cores of the GPU to perform the matrix multiplication associated with calculating the one dimensional DFTs can provide significant performance benefits due to the cores' optimization for such operations.

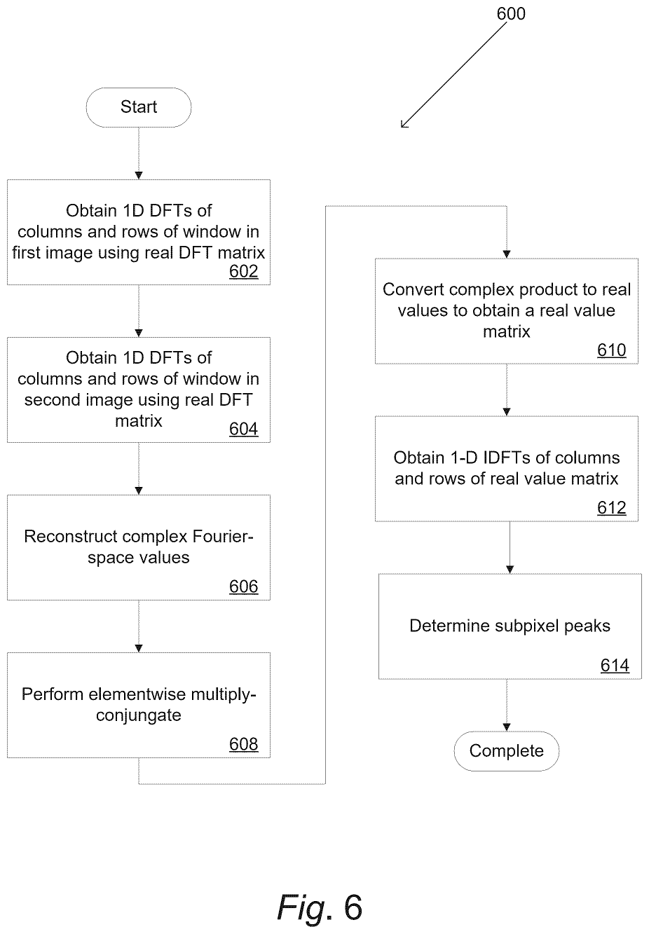

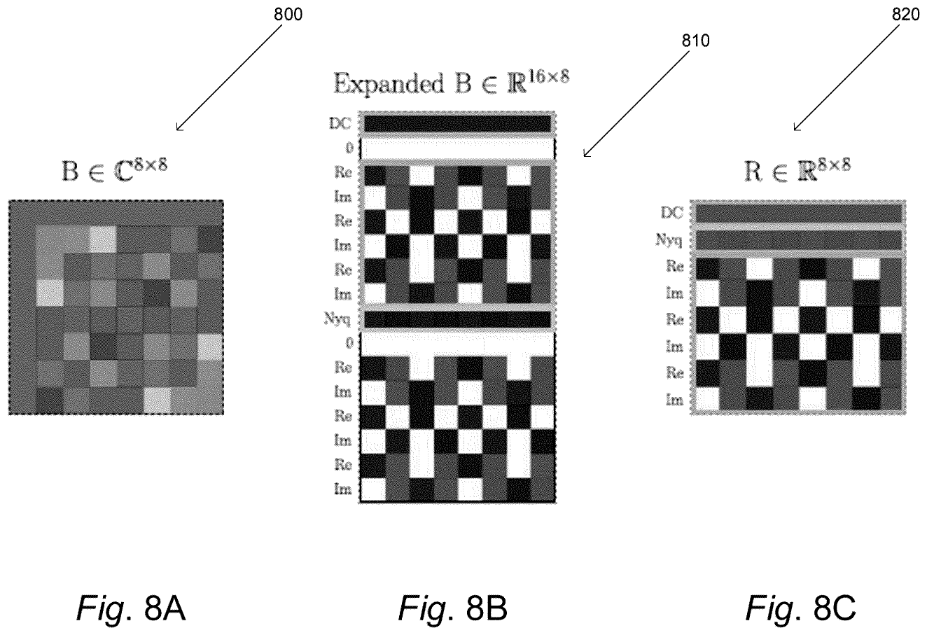

A process for performing separable window correlation using GPU tensor processing cores in accordance with an embodiment of the invention is illustrated in FIG. 6. The process 600 begins with obtaining (602) one dimensional discrete Fourier transforms (DFT) of the columns and the rows of a window in a first image using real DFT matrices. Following this, the process 600 continues with obtaining (604) one dimensional DFT of the columns and rows of a corresponding window in a second image using real DFT matrices. Processes for constructing the real DFT matrices in accordance with various embodiments of the invention are discussed further below with reference to FIGS. 8A-8C.

Referring again to FIG. 6, the process 600 reconstructs (606) complex Fourier space values for the 2D discrete Fourier transform obtained using the real DFT matrices. After reconstruction, the process 600 performs (608) elementwise multiply-conjugate operations with respect to reconstructed complex Fourier space values. The process 600 converts (610) complex products to real values to obtain a real value matrix. Following this conversion, the process 600 involves obtaining (612) one dimensional inverse discrete Fourier transforms (IDFTs) of rows and columns of the real value matrix. The process 600 concludes by determining (614) subpixel peaks based upon output of 1D IDFTs.

Although specific processes for performing optical flow are discussed above with reference to FIG. 6, alternative processes that utilize separable window correlation can be performed as appropriate to the requirements of specific applications in accordance with various embodiments of the invention.

### Implementations of Optical Flow Processes

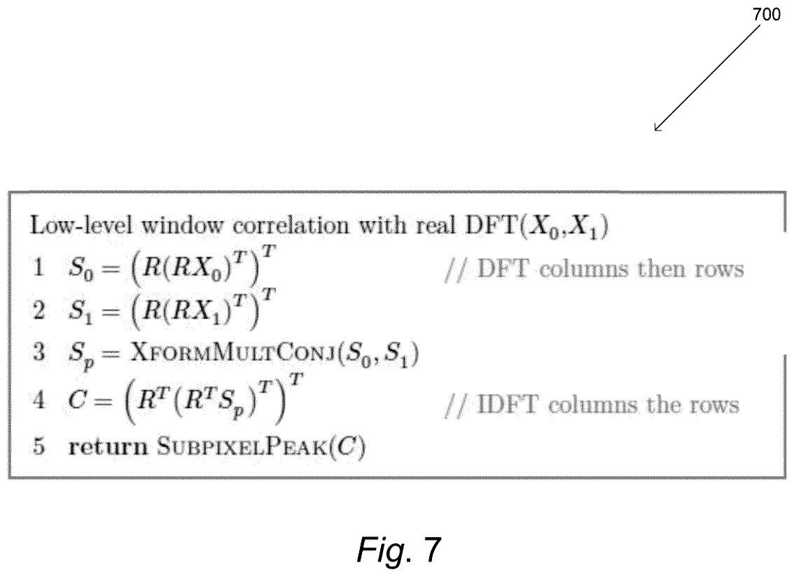

Optical flow processes can be implemented in a variety of ways in accordance with several embodiments of the invention. Operations for obtaining subpixel peaks by performing separable window correlation using GPU tensor processing cores in accordance with an embodiment of the invention are illustrated in FIG. 7. The operations 700 involve a series of steps for performing window correlation using real DFT operations. The process begins with 1D DFT column operations followed by 1D DFT row operations on input windows, transforming them into the Fourier frequency domain. A specialized multiply-conjugate operation can then be performed between both of the transformed windows. The process concludes with inverse DFT operations to transform the result back to the spatial domain to enable the location of the subpixel peak position in the resulting correlation surface. While much of the discussion that follows refers to the application of 1D transforms on columns followed by rows, it should be readily appreciated that the same processes can be performed on rows follows by columns as appropriate to the requirements of specific applications in accordance with various embodiments of the invention.

Although specific operations for performing optical flow are discussed above with reference to FIG. 7, alternative processes that utilize separable window correlation can be performed as appropriate to the requirements of specific applications in accordance with various embodiments of the invention.

### Generation of Real Discrete Fourier Transform Matrices

A process for generating a real discrete Fourier transform matrix in accordance with an embodiment of the invention is illustrated in FIGS. 8A-8C. The process involves transforming a complex discrete Fourier transform (DFT) matrix into a real DFT matrix that can be efficiently utilized by the tensor processing cores of the graphics processing unit (GPU) 308.

In some cases, the transformation process may begin with a complex discrete Fourier transform matrix 800, as shown in FIG. 8A. The complex discrete Fourier transform matrix 800 may contain complex values representing both magnitude and phase information for each frequency component.

To derive a one-dimensional real DFT matrix, the process can expand each complex row of the complex discrete Fourier transform matrix 800 into two real rows: one row containing the real components and another row containing the imaginary components. This expansion results in an expanded matrix 810, as illustrated in FIG. 8B. In the illustrated embodiment, the complex discrete Fourier transform matrix 800 is [symbol] 8×8 the expanded matrix 810 may be in [symbol] ^{16×8} format, effectively doubling the number of rows while maintaining the same number of columns as the original complex matrix.

In the expanded matrix 810, the process can pack the Nyquist row into the empty row below the DC (direct current) row. This packing technique allows for efficient representation of all necessary frequency components while eliminating redundant information.

After removing redundant rows from the expanded matrix 810, the process may arrive at a real discrete Fourier transform matrix 820, as shown in FIG. 8C. In the illustrated embodiment, the real discrete Fourier transform matrix 820 may be in [symbol] ^{8×8} format and may be generated using the expanded matrix 810. Each element of the real discrete Fourier transform matrix 820 at row r and column c may be defined by the following formula:

$${R}_{r , c}^{′} := \{ \begin{matrix}1 & if r = 0 \\ cos ( π c ) & if r = 1 \\ cos ( {α}_{⌊ r / 2 ⌋} c ) & if r \geq 2 and r is even \\ sin ( {α}_{⌊ r / 2 ⌋} c ) & if r \geq 3 and r is odd\end{matrix}$$

where αₖ represents the frequency component associated with each row. For a vector of length W, there is an associated length-W vector of wavenumbers:

$${α}_{k} := - \frac{2 π}{W} k$$

where k∈{0,1, . . . , W−1}. The wavenumbers represent the frequency components associated with each row in the real discrete Fourier transform matrix, providing a mapping between the spatial and frequency domains.

The real discrete Fourier transform matrix 820 maintains mathematical equivalence to the complex discrete Fourier transform matrix 800 while operating only on real values. This property allows the matrix to be efficiently utilized by the tensor processing cores of the graphics processing unit (GPU) 308, which may be optimized for real-value operations.

In some implementations, the DC and Nyquist rows may be scaled by a factor of

$$\frac{\sqrt{2}}{2}$$

to so that the resulting real discrete Fourier transform matrix is orthogonal. Each element R_{r,c} of this matrix, with row r and column c, is as follows:

$${R}_{r , c} := \{ \begin{matrix}\frac{\sqrt{2}}{2} & if r = 0 \\ \frac{\sqrt{2}}{2} cos ( π c ) & if r = 1 \\ cos ( {α}_{⌊ r / 2 ⌋} c ) & if r \geq 2 and r is even \\ sin ( {α}_{⌊ r / 2 ⌋} c ) & if r \geq 3 and r is odd\end{matrix}$$

The resulting matrix R has the property of orthogonality, which can be expressed mathematically as:

$${R}^{T} R = \frac{W}{2} I$$

where R^{T} denotes the transpose of R, and I represents the identity matrix.

This formulation of the real one dimensional discrete Fourier transform matrix can provide certain advantages in terms of computational efficiency and numerical stability when used in optical flow calculations on GPU tensor processing cores. The orthogonality property, in particular, can be leveraged in optical flow processes implemented in accordance with various embodiments of the invention to simplify certain matrix operations and reduce computational complexity.

Although a specific process for generating a real discrete Fourier transform matrix is discussed above with reference to FIGS. 8A-8C, alternative processes for transforming complex DFT matrices into real DFT matrices including matrices having different dimensions can be performed as appropriate to the requirements of specific applications in accordance with various embodiments of the invention.

Obtaining 2D DFTs from 1D Real DFT Transforms

In optical flow calculations implemented in accordance with a number of embodiments of the invention, the outputs obtained using real DFT matrices are converted to complex Fourier space to perform elementwise multiply-conjugate calculations. Real DFT matrices, while efficient for computation on GPU tensor processing cores, do not directly provide a complex frequency domain representation that can be utilized to perform correlation operations. The real DFT transformation process does, however, allow for the reconstruction of complex Fourier space values, enabling subsequent multiply-conjugate operations.

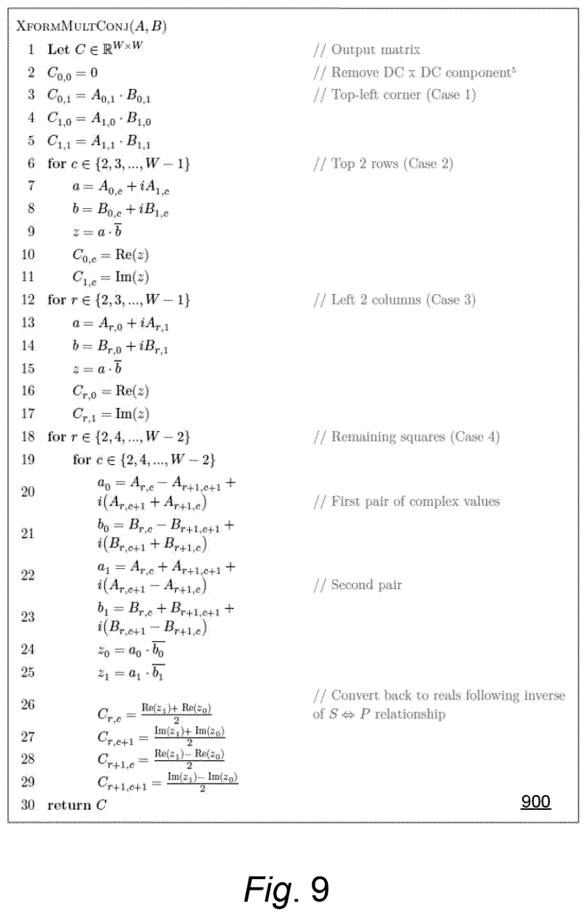

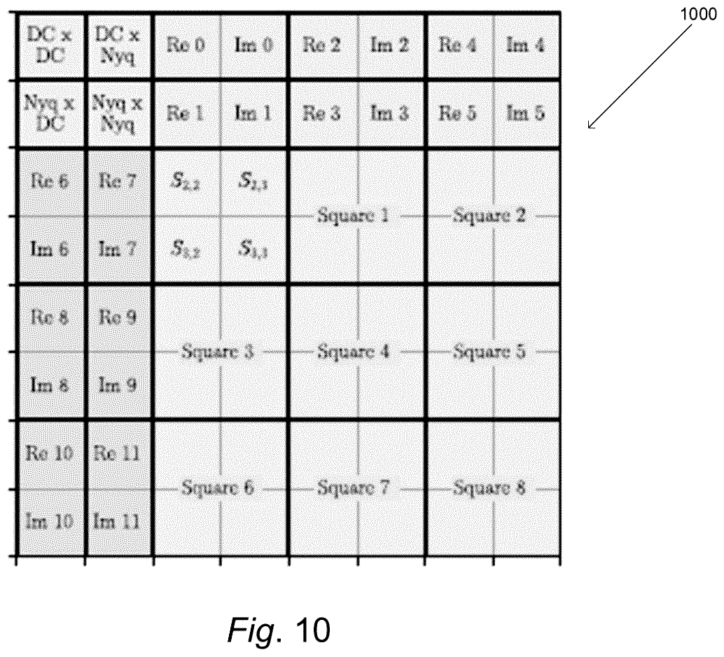

Operations performed to transform outputs obtained using real DFT matrices to complex Fourier space in accordance with an embodiment of the invention are illustrated in FIG. 9. The operations 900 involve a series of steps that handle different cases in the transformation process. A visual representation of the four cases that are considered in reconstructing complex Fourier space values for the 2D discrete Fourier transform from the outputs obtained using real DFT matrices in accordance with an embodiment of the invention is illustrated in FIG. 10, which shows 1000 a matrix layout divided into distinct regions that correspond to different reconstruction cases.

In some cases, the transformation process may begin with removing the DC×DC component. This step can be performed to prevent potential floating-point overflow and may not affect the final optical flow vector calculation.

For Case 1, which corresponds to purely real values (u=0, v=0), the process can handle the top-left corner values of the matrix. The reconstruction of complex Fourier space values for this case may be performed using the following equations:

$${S}_{0 , 0} = \frac{1}{2} {F}_{0 , 0}$$

$${S}_{0 , 1} = \frac{1}{2} {F}_{0 , W / 2}$$

$${S}_{1 , 0} = \frac{1}{2} {F}_{W / 2 , 0}$$

$${S}_{1 , 1} = \frac{1}{2} {F}_{W / 2 , W / 2}$$

where S represents the output matrix from the real DFT, and F represents the complex Fourier space values.

For Case 2 (u=0, v≥2), which corresponds to the top two rows of the matrix excluding the top-left corner, the reconstruction may be performed as follows:

$$\frac{\sqrt{2}}{2} {F}_{0 , v / 2} = {S}_{0 , v} + {iS}_{0 , v + 1}$$

$$\frac{\sqrt{2}}{2} {F}_{W / 2 , v / 2} = {S}_{1 , v} + {iS}_{1 , v + 1}$$

Case 3 (u≥2, v=0) may handle the left two columns of the matrix excluding the top-left corner. The reconstruction for this case may be similar to Case 2, but with the roles of u and v interchanged:

$$\frac{\sqrt{2}}{2} {F}_{u / 2 , 0} = {S}_{u , 0} + {iS}_{u + 1 , 0}$$

$$\frac{\sqrt{2}}{2} {F}_{u / 2 , W / 2} = {S}_{u , 1} + {iS}_{u + 1 , 1}$$

For Case 4 (u, v∈[2, W)), which covers the remaining squares of the matrix, the reconstruction may involve more involved calculations:

$${F}_{u / 2 , v / 2} = ( {S}_{u , v} - {S}_{u + 1 , v + 1} ) + i ( {S}_{u , v + 1} + {S}_{u + 1 , v} )$$

$${F}_{W - u / 2 , v / 2} = ( {S}_{u , v} + {S}_{u + 1 , v + 1} ) + i ( {S}_{u , v + 1} - {S}_{u + 1 , v} )$$

These equations allow for the reconstruction of two non-redundant complex values from a 2×2 submatrix of S.

After reconstructing the complex Fourier space values, the process can perform elementwise multiply-conjugate operations. These operations can enable computation of the correlation between windows from different images, which forms the basis for optical flow estimation.

The various implementations of the XformMultConj function described above may be optimized for efficient execution on GPU architectures. This optimization can accelerate all cases of the transformation process, including Case 4, which may be the most computationally and memory-intensive. Acceleration can be achieved through a specialized implementation that leverages the specific layout of the tiled matrix multiply-accumulate (MMA) operator often used in GPU tensor processing cores.

For Case 4, which involves accessing all 4 values within a 2×2 square of the matrix, the implementation may take advantage of the thread-value layout to optimize data transfer between threads. In this layout, the top 2 values of a 2×2 square may be owned by one thread, while the bottom 2 values may be owned by another thread offset by 4. Both threads may require access to all 4 values to perform the necessary calculations.

Instead of using shared memory for inter-thread communication, which is typically required for such data transfers, the implementation may utilize warp shuffle operations. Warp shuffles may allow for direct transfer of values between threads within the same warp when those values are stored in the same register number across threads. This approach is possible in many embodiments of the invention due to the specific value index alignment in the thread-value layout used in the tiled MMA operator. By leveraging warp shuffles, the process can achieve more efficient data transfer and potentially reduce overall computational overhead in the optical flow calculation process.

Although specific operations for transforming outputs and performing elementwise multiply-conjugate calculations are discussed above with reference to FIG. 9 and FIG. 10, alternative processes that utilize different mathematical formulations or matrix layouts can be performed as appropriate to the requirements of specific applications in accordance with various embodiments of the invention.

### Efficient Implementations of ArgMax Operations

In optical flow processes, the ArgMax calculation can play a crucial role in determining the peak correlation between image windows. However, this calculation can be computationally expensive, consuming a significant portion of the total processing time. In some implementations, the ArgMax calculation may account for approximately 20% of the entire optical flow process execution time. By optimizing the ArgMax calculation for GPU tensor processing cores, optical flow processes may achieve substantial performance improvements in terms of both latency and throughput.

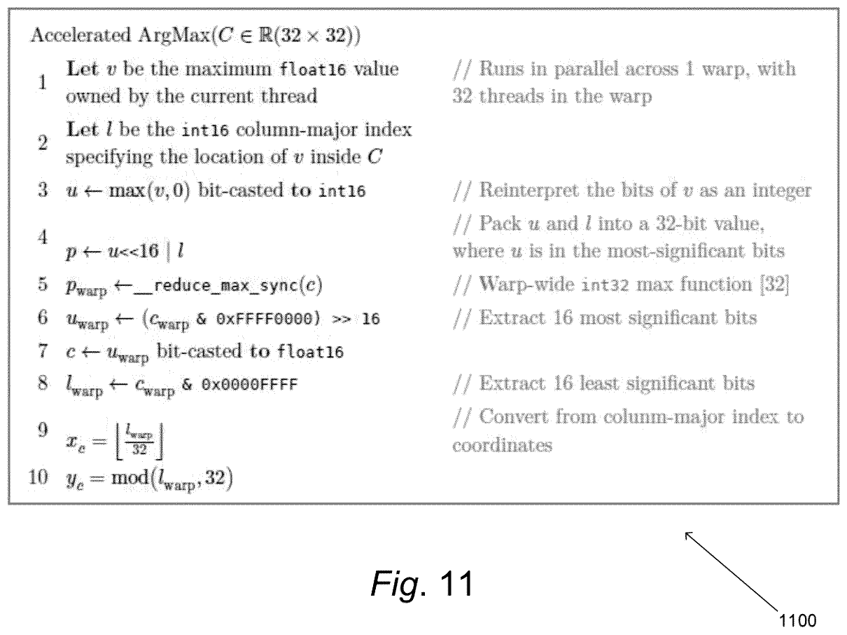

Operations performed to accelerate ArgMax calculation using GPU tensor processing cores in accordance with an embodiment of the invention are illustrated in FIG. 11. The operations 1100 are designed to leverage the parallel processing capabilities of GPU tensor cores, enabling efficient execution of the ArgMax calculation on large matrices.

In some cases, the accelerated ArgMax calculation may be implemented to run in parallel across a single warp containing 32 threads. Each thread may own a portion of an input matrix C and maintain two key values: v, which represents the maximum float16 value owned by that thread, and l, which stores the int16 column-major index specifying the location of v within matrix C.

The process may begin by comparing the float16 value v with 0 and bit-casting the maximum to int16 format (u). This operation ensures that all values being compared are positive, which is necessary for the validity of the subsequent integer comparisons. The comparison and bit-casting can be expressed mathematically as:

$$u ← max ( v , 0 ) bit - casted to int16$$

Next, the process may left-shift the value u by 16 bits and combine it with l using a bitwise OR operation to create p. This step effectively packs the maximum value and its index into a single 32-bit integer, allowing for efficient comparison and reduction operations:

$$p ← u ≪ 16 \vert l$$

The process may then apply a warp-wide int32 max function to p to find p_{warp}. This operation leverages the GPU's ability to perform efficient parallel reductions across threads within a warp:

$${p}_{warp} ← \_reduce \_max \_sync ( p )$$

Following the warp-wide int32 max function, the process can extract the 16 most significant bits from p_{warp} by masking with 0xFFFF0000 and right-shifting by 16 to obtain u_{warp}. This value may then be bit-cast back to float16 to obtain c, which represents the maximum value across the entire warp:

$${u}_{warp} ← ( {p}_{warp} \& 0 xFFFF 0000 ) ≫ 16$$

$$c ← {u}_{warp} bit - casted to float16$$

The process may also extract the 16 least significant bits from p_{warp} using a mask of 0x0000FFFF to obtain I_{warp}, which represents the index of the maximum value:

$${l}_{warp} ← {p}_{warp} \& 0 x 0000 FFFF$$

Finally, the process may calculate ye as the modulo of l_{warp} with 32, converting the column-major index to a row index within the matrix:

$${y}_{c} = mod ( {l}_{warp} , 32 )$$

After performing the accelerated ArgMax calculation, the process may use warp shuffles to send the remaining stencil values (up, down, left, right) to thread 0, and perform the sub-pixel refinement calculation on thread 0. This approach allows for efficient communication of values between threads within the same warp, minimizing the need for more expensive memory operations. In other embodiments, any of a variety of stencils appropriate to the requirements of specific applications can be utilized. In certain embodiments, it may also be faster to send the up, down, left, right values through shared memory instead of using warp shuffles. As can readily be appreciated, the specific manner in which the up, down, left, right values are processed is largely dependent upon the requirements of specific applications.

The accelerated ArgMax calculation may be particularly effective when implemented on the graphics processing unit (GPU) 308, leveraging the parallel processing capabilities of the parallel processing units 312. By utilizing the tensor processing cores within these units, the ArgMax calculation may achieve significantly improved performance compared to traditional implementations.

Although a specific process for accelerating ArgMax calculations is discussed above with reference to FIG. 11, alternative processes that utilize different optimization techniques or leverage different GPU architectures can be performed as appropriate to the requirements of specific applications in accordance with various embodiments of the invention.

In optical flow processes implemented on GPU architectures, efficient matrix transposition can be beneficial for achieving high performance. In a number of embodiments, a matrix transposition approach is utilized that leverages the properties of tensor cores to perform this operation entirely within registers, without relying on shared memory or specialized instructions. This method can provide significant speed improvements over more conventional transposition techniques. By rearranging data through register swapping rather than memory transfers, the transposition process can be completed more rapidly, potentially reducing latency and increasing overall throughput. This register-based transposition technique may be particularly well-suited for the repetitive matrix operations common in separable DFT processes implemented in accordance with various embodiments of the invention, where frequent transpositions are used between successive matrix multiplications. The ability to perform these transpositions with minimal overhead can contribute to more efficient utilization of GPU resources and enhanced performance in optical flow calculations.

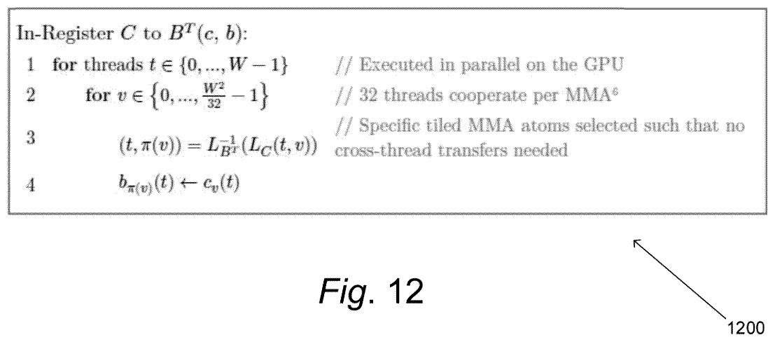

Operations performed to perform matrix transposition via register reassignment and without use of shared memory in accordance with an embodiment of the invention are illustrated in FIG. 12. The operations 1200 enable efficient in-register matrix transposition from matrix C to matrix B transpose without requiring shared memory or cross-thread communication.

In some cases, the in-register matrix transposition may begin with matrix C distributed across the registers of multiple threads in the graphics processing unit (GPU) 308. The goal of the transposition is to rearrange the elements of matrix C into the configuration of matrix B transpose, entirely within the registers of the GPU.

The process may involve a nested loop structure that executes in parallel across GPU threads. The outer loop may iterate over threads/in the range of 0 to W−1, where W represents the window size. This loop may be executed in parallel on the parallel processing units 312 of the GPU 308.

Within each thread, an inner loop may iterate over values v in the range of 0 to (W²/32)−1. In some implementations, the inner loop may include the following operations:
1. A mapping operation that determines the permutation index π(v) by calculating:

$$( t , π ( v ) ) = {L}_{{B}^{T}}^{- 1} ( {L}_{C} ( t , v ) )$$

where L_{C} and L_{B}_{^{T}} are layout functions that define how register indices map to positions in the full matrices C and B^{T}, respectively.
2. An assignment operation that moves values from matrix C to matrix B^{T} using the calculated permutation:

$${b}_{π ( v )} ( t ) ← {c}_{v} ( t )$$

This operation effectively rearranges the elements within each thread's registers to achieve the desired transposition.

The operations may be designed to enable the tensor processing cores within the parallel processing units 312 to perform the matrix transposition entirely within registers. By carefully selecting the tiled matrix multiply-accumulate (MMA) atoms and thread-value layout, the process may avoid the need for shared memory or cross-thread communication.

In some cases, the efficiency of this in-register transposition may be due to the specific layout of the tiled MMA operator used in the tensor processing cores. For example, with certain MMA layouts, the values in each thread for the output matrix C may be the same values needed in that thread for the next input matrix B transpose, only in a different order. This property allows the transposition to be achieved through a simple permutation of values within each thread's registers.

Although specific operations for performing in-register matrix transposition are discussed above with reference to FIG. 12, alternative processes that utilize different permutation schemes or leverage different GPU architectures can be performed as appropriate to the requirements of specific applications in accordance with various embodiments of the invention.

### Performance of Optical Flow Processes on Various GPU Architectures

Optical flow processes implemented in accordance with various embodiments of the invention may achieve significant performance improvements compared to previous methods. These improvements may be particularly notable in terms of throughput and latency, enabling real-time processing of high-resolution image streams on various GPU architectures.

In many embodiments, the machine vision system may implement batching techniques to enhance computational throughput and optimize resource utilization. Batching may involve processing multiple image pairs within common GPU kernel calls, which can improve memory bandwidth usage by reducing the overhead associated with individual kernel launches. This approach may also amortize initialization costs across multiple optical flow calculations, including the setup of real DFT matrices and allocation of processing resources within the tensor processing cores.

The batch size may be optimized based on the specific performance requirements and hardware characteristics of the machine vision system. In some implementations, batch sizes in the range of 10 to 200 image pairs may provide near-optimal throughput performance, with certain configurations achieving maximum throughput at batch sizes of approximately 95. The optimal batch size may vary depending on factors such as available GPU memory, the dimensions of the input images, and the specific tensor processing core architecture being utilized.

Machine vision systems implemented in accordance with various embodiments of the invention may be configured to balance the trade-off between batching for improved throughput and processing individual image pairs for minimum latency. When maximum throughput is desired, such as in batch processing applications or high-volume video analysis, batching may be enabled to achieve optimal performance. Conversely, when minimum latency is critical, such as in real-time autonomous vehicle applications or interactive machine vision systems, batching may be disabled to process each image pair immediately upon receipt, thereby reducing the overall system response time.

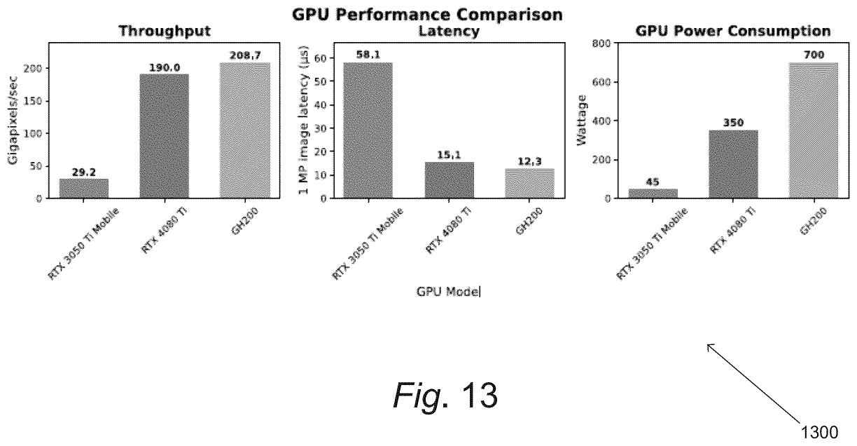

Charts showing performance of optical flow processes implemented in accordance with various embodiments of the invention on different GPU architectures are illustrated in FIG. 13. The charts 1300 demonstrate the performance characteristics of the optical flow process across three different GPU models: the RTX 3050 Ti Mobile, the RTX 4080 Ti, and the GH200. The performance of the optical flow process may vary depending on the specific implementation and hardware configuration. In some cases, the process may use a batch processing (i.e. reusing the Si matrix as S₀ for the next image pair, without re-calculating or reloading the image from memory) for maximum throughput. Alternatively, batching can be disabled for minimum latency.

Although specific implementations and performance characteristics are discussed above, alternative implementations of the described techniques are possible within the scope of the invention. The techniques described are not limited to performing optical flow calculations but can be utilized to perform other machine vision processes involving comparisons of windows or patches of images including (but not limited to) performing disparity searches and depth estimation in monocular and multiview stereo applications. Furthermore, the techniques are not limited to increasing the efficiency of discrete Fourier transformations, but can be leveraged to perform any of a variety of image processing transformations including (but not limited to) discrete cosine transformations in which 2D transformations can be decomposed into 1D real value transformations. These techniques may be applied to various components of the machine vision processing system, such as the parallel processing units within the graphics processing unit (GPU), to enhance the efficiency of image processing operations across different hardware architectures and application domains. While the processes described herein can be implemented on the various machine vision processing systems described herein, including those described above with respect to FIG. 3, it should be appreciated that the processes can be implemented using any of a variety of machine vision processing systems incorporating GPUs (or other processing devices) having tensor processing cores as appropriate to the requirements of specific applications in accordance with various embodiments of the invention.

### Portable Real-Time Optical Flow Field Sensors

Particle Imaging Velocimetry (PIV) is a well-established technique for measuring flow fields in fluids by seeding the fluid with particles, illuminating them with a laser, and imaging the motion of the particles with cameras. The introduction of digital PIV enabled computational processing of particle motion data, but PIV processing has remained computationally intensive and typically requires lengthy post-processing periods.

Real-time PIV (RTPIV) systems have been developed to provide flow field information before the analyzed system evolves to a new state. Real-time processing capabilities can enable feedback control, active human interaction, and reduced data storage requirements by saving only processed results rather than storing raw images. However, existing RTPIV implementations have been limited by computational requirements and hardware constraints.

Historical developments in RTPIV have primarily relied on improvements in computational hardware rather than algorithmic efficiency gains. Early RTPIV systems utilized Field-Programmable Gate Arrays (FPGAs) for processing, while later implementations leveraged Central Processing Units (CPUs) and Graphics Processing Units (GPUs). The advent of scientific GPU computing enabled RTPIV processing at rates of dozens to hundreds of frames per second on high-power desktop computers.

Despite general hardware advancements, existing RTPIV solutions have remained impractical for portable applications due to several limitations. Power efficiency requirements, size constraints, robustness demands, and throughput necessities for portable applications have remained unmet by conventional approaches.

Optical configuration limitations have further restricted the portability of conventional PIV systems. Traditional PIV setups often require bulky pulsed lasers and optical components positioned at multiple points surrounding the measurement volume. These configurations typically need multiple points of optical access, multiple mounting points, and controlled low ambient lighting conditions. The requirement for precise alignment and calibration of spatially distributed components has made existing systems unsuitable for field applications.

Conventional PIV systems have also been limited to measuring in-plane velocity components, requiring precise alignment with the dominant flow plane. This restriction has limited the applicability of existing systems to quasi-two-dimensional flow fields. Additionally, traditional side-scatter optical configurations have provided limited laser light return to cameras, necessitating high-power laser sources that are incompatible with portable form factors.

The systems and methods described above can be utilized in a variety of systems including portable hand-held optical flow measurement systems, which overcome previous computational constraints and can enable real-time PIV processing. In many embodiments, the portable systems can perform real-time measurement of flow fields in dynamic environments by combining optical components with computational processing capabilities. In several embodiments, the portable systems utilize stereographic imaging configurations to capture particle motion within illuminated measurement planes, enabling three-component velocity reconstruction. The computational processing can leverage the efficient optical flow algorithms described above to provide real-time analysis of captured image data, allowing for immediate feedback and data visualization in field applications.

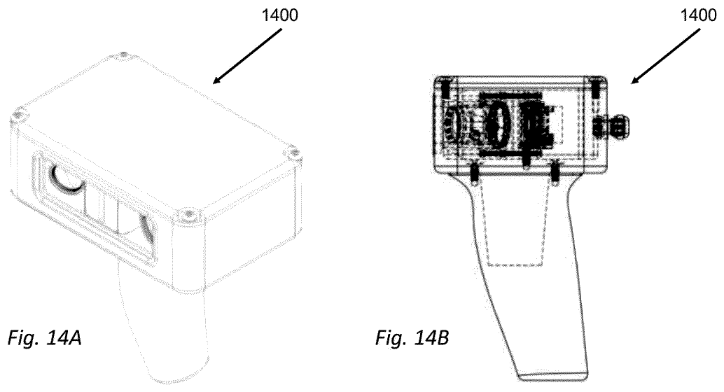

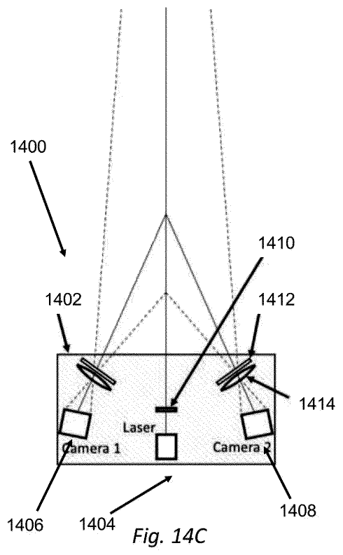

A hand-held optical flow measurement system in accordance with an embodiment of the invention is illustrated in FIG. 14A and FIG. 14B. The hand-held optical flow measurement system 1400 may include a housing with a rectangular body portion mounted on a stem or post-like structure. The housing may contain optical components and processing electronics in a compact form factor suitable for portable field applications. While a specific housing is illustrated in FIGS. 14A and 14B, it should be readily appreciated that any housing shape can be utilized as appropriate to the requirements of specific applications.

The internal optical components of the hand-held optical flow measurement system 1400 are shown in FIG. 14C. The housing 1402 contains a laser 1404, a first camera 1406, and a second camera 1408. The laser 1404 directs light toward a beamshaping optic 1410 that shapes the laser output into a sheet of light for illuminating particles within a measurement plane. In a number of embodiments, a chromatic filter 1412 is positioned in front of each of the cameras to improve signal-to-noise ratio by filtering ambient light while allowing laser light to pass through. Each camera may incorporate a Scheimpflug lens 1414 that enables focusing across the measurement plane even when the cameras are positioned at acute viewing angles. The first camera 1406 and the second camera 1408 may be arranged in a stereographic configuration within the housing 1402 to capture images from different perspectives, enabling reconstruction of three-dimensional velocity components within the laser sheet plane. The ability to reconstruct three-dimensional velocity components is advantageous for portability because it can prevent the need to precisely align the system to the dominant plane of the flow, and remove the restriction of quasi-two-dimensionality from the set of flow fields the device can measure. In addition, the stereographic configuration not only improves the form factor and eliminates the need for multiple points of access to a flow, but can also increase the laser light returned to the camera by a factor of ˜10 because it is a backscatter configuration rather than a side-scatter configuration which is traditionally used. In many embodiments, the hand-held optical flow measurement system 1400 enables in-air flow sensing with a simple diode laser instead of bulky, inefficient, and expensive Q-switched pulse lasers.

In a number of embodiments, the hand-held optical flow measurement system 1400 incorporates a GPU and utilizes the optical flow processing techniques described above to analyze captured image data in real-time. In several embodiments, the image data input is provided to a machine vision processing system (e.g. the machine vision system 302 described above with reference to FIG. 3) that includes the graphics processing unit (GPU) 308 with tensor processing cores for performing the efficient optical flow calculations. The machine vision system can then perform any (or all) of the processes described above with respect to FIGS. 4-12. The portable nature of the system may enable flow field measurements in locations where traditional laboratory-based systems would be impractical, such as outdoor environments or confined spaces. In several embodiments, the hand-held optical flow measurement system 1400 provides image data to an external system via a wired and/or wireless connection, where the external system is a machine vision processing system (e.g. the machine vision system 302 described above with reference to FIG. 3) that includes the graphics processing unit (GPU) 308 with tensor processing cores for performing the efficient optical flow calculations. The machine vision system can then perform any (or all) of the processes described above with respect to FIGS. 4-12.

In a number of embodiments, the portable optical flow measurement system 1400 incorporates software that performs multiple functions to enable real-time PIV processing. In addition to optional on-line display, compression, storage, and data transfer capabilities, the software may be configured to perform PIV calculations at rates well above standard video rates using the efficient optical flow techniques described herein.

In some embodiments, a minimal software implementation involves image de-warping to eliminate perspective distortion, data handling for passing camera data to the GPU tensor processing cores, and three-dimensional velocity reconstruction from the two-dimensional fields produced by the stereographic camera configuration. However, to achieve enhanced accuracy and hardware-agnostic precision, the software may perform additional pre-processing and post-processing steps.

In many embodiments, the software includes instructions that cause the system to control and synchronize multiple cameras, as well as read image data from the cameras with low latency and without dropping frames. The software may apply high-pass filtering to eliminate out-of-focus background noise and effects of non-uniform illumination. In several embodiments, the software may detect particle seeding density and exposure using statistical analysis techniques, such as probability density function analysis. Based on this analysis, the software may automatically adjust camera exposure time and gain in real-time to accommodate dynamic environmental conditions typical of portable system operation.

The software may include automatic detection capabilities for under-seeding and over-seeding conditions. In a final pre-processing step, the software may enhance image contrast and eliminate image distortion based on a warping function generated from a one-time calibration performed during system assembly. In many embodiments, the software may incorporate calibration routines that utilize the fixed geometric relationships between camera sensors, optics, and laser sheet positioning within the portable housing. These calibration routines may be performed once during system assembly and may remain valid indefinitely due to the rigid mounting configuration of the optical components. In other embodiments, dynamic calibrations can be performed to update calibration throughout the operational lifetime of the portable optical flow measurement system 1400. As can readily be appreciated, the specific calibration processes that are utilized are largely dependent upon the requirements of specific applications.

In many embodiments, the software may utilize the GPU tensor processing cores to determine velocity fields between sequential images from each camera perspective using the separable window correlation techniques described herein. The software may perform one-dimensional discrete Fourier transform calculations using real discrete Fourier transform matrices on the GPU tensor processing cores, enabling efficient processing of the stereographic image data.

The software may implement velocity field refinement processes that operate on the output from the tensor processing core calculations. The refinement process may include detection of erroneous vectors followed by replacement using interpolation techniques. The software may then refine the corrected velocity field by distorting images according to existing velocity estimates and performing sub-pixel velocity refinement on residual particle displacements. In many embodiments, the refinement process can be performed iteratively.

In some embodiments, the software may detect and replace erroneous vectors in the refined velocity field estimate using interpolation methods. The software may perform matrix transposition operations using the register-based techniques described herein to optimize data flow between processing stages.

The software may include real-time display capabilities that provide immediate visualization of flow field measurements. In some embodiments, the software may implement data compression and storage functions that allow operators to selectively retain processed field data rather than storing raw image sequences, thereby reducing storage requirements for extended field operations.

In many embodiments, the software may be optimized to achieve power efficiency suitable for portable operation while maintaining real-time processing capabilities. The efficient utilization of GPU tensor processing cores for the computationally intensive correlation operations may enable the system to operate within power constraints that would be impractical for conventional exhaustive search algorithms.

Although specific implementations of portable optical flow measurement systems are discussed above with reference to FIG. 14A-14C, alternative implementations of the described techniques are possible within the scope of various embodiments of the invention. The techniques described herein are not limited to performing optical flow using the particular hardware form-factors described above. The disclosed methods can be leveraged to perform various image processing transformations on a variety of different hardware platforms including (but not limited to) desktop computer systems, mobile computing devices, embedded systems, robotics platforms, and distributed computing architectures. In addition, the efficient matrix operations and tensor core utilization described above may be applied to other computational tasks that involve discrete Fourier transforms or similar mathematical operations in machine vision applications.

While the above description contains many specific embodiments of the invention, these should not be construed as limitations on the scope of the invention, but rather as an example of one embodiment thereof. Furthermore, submitted herewith are a number of Exhibits that contain additional disclosure and that are incorporated herein by reference in their entirety. Accordingly, the scope of the invention should be determined not by the embodiments illustrated, but by the appended claims and their equivalents.

What is claimed is:

1. A machine vision system, comprising:
a camera;
a processor;
a processor comprising tensor processing cores; and
a memory containing instructions that, when executed by the processor, cause the machine vision system to:
obtain a pair of sequential input images from the camera;
identify windows in the input images;
perform optical flow calculations using separable window correlation, where:
the separable window correlation calculations comprise performing one-dimensional Discrete Fourier Transform (DFT) calculations using the tensor processing cores, and
the one-dimensional DFT calculations are performed on the tensor processing cores using real Discrete Fourier Transform matrices; and
output optical flow information for the input images.

2. The machine vision system of claim 1, wherein the instructions further cause the machine vision system to generate the real Discrete Fourier Transform matrices by:
expanding a complex Discrete Fourier Transform matrix into an expanded matrix;
removing redundant rows from the expanded matrix; and
scaling DC and Nyquist rows of the resulting matrix.

3. The machine vision system of claim 2, wherein one of real Discrete Fourier Transform matrices R is defined by:
$${R}_{r , c} := \{ \begin{matrix}\frac{\sqrt{2}}{2} & if r = 0 \\ \frac{\sqrt{2}}{2} cos ( π c ) & if r = 1 \\ cos ( {α}_{⌊ r / 2 ⌋} c ) & if r \geq 2 and r is even \\ sin ( {α}_{⌊ r / 2 ⌋} c ) & if r \geq 3 and r is odd\end{matrix}$$
where αₖ represents a frequency component associated with each row.

4. The machine vision system of claim 1, wherein the instructions further cause the machine vision system to reconstruct complex Fourier space values for the 2D discrete Fourier transform from outputs of the real Discrete Fourier Transform matrices by:
removing a DC×DC component;
handling top-left corner values;
processing top two rows and left two columns; and
reconstructing remaining complex values using 2×2 submatrices.

5. The machine vision system of claim 4, wherein reconstructing the remaining complex values comprises:
for a 2×2 submatrix with top-left corner (u,v), calculating:
$${F}_{u / 2 , v / 2} = ( {S}_{u , v} - {S}_{u + 1 , v + 1} ) + i ( {S}_{u , v + 1} + {S}_{u + 1 , v} )$$
$${F}_{W - u / 2 , v / 2} = ( {S}_{u , v} + {S}_{u + 1 , v + 1} ) + i ( {S}_{u , v + 1} - {S}_{u + 1 , v} )$$
where F represents complex Fourier space values for the 2D discrete Fourier transform, S represents outputs of the real Discrete Fourier Transform matrices, and W is the window size.

6. The machine vision system of claim 1, wherein the instructions further cause the machine vision system to accelerate an ArgMax calculation by:
bit-casting float16 values to int16 format;
packing maximum values and their indices into single 32-bit integers;
performing a warp-wide int32 max reduction; and
extracting a maximum value and its index from the reduction result.

7. The machine vision system of claim 6, wherein accelerating the ArgMax calculation further comprises:
comparing float16 values with zero and bit-casting the maximum to int16 format;
left-shifting the bit-cast value by 16 bits and combining it with an index;
applying a warp-wide int32 max function to the combined value; and
extracting a maximum value and its index from the reduction result using bit masking and shifting operations.

8. The machine vision system of claim 1, wherein the instructions further cause the machine vision system to accelerate matrix transposition by:
executing a nested loop structure in parallel across GPU threads;
determining a permutation index for each value in a first matrix (C); and
reassigning values to a matrix transpose (B^{T}) based on the determined permutation indices.

9. The machine vision system of claim 8, wherein determining the permutation index comprises calculating:
$${L}_{{B}^{T}}^{- 1} ( {L}_{C} ( t , v ) )$$
where L_{C} and L_{B}_{^{T}} are layout functions that define how register indices map to positions in the full matrices C and B^{T}, respectively, t is a thread index, and v is a value index within the thread.

10. The machine vision system of claim 1, wherein the windows in the input images are 32 pixels by 32 pixels.

11. A method for performing optical flow in a machine vision system, the method comprising:
obtaining, using a processor, a pair of sequential input images;
identifying, using the processor, windows in the input images;
performing, using a processor incorporating at least one tensor processing core, optical flow calculations using separable window correlation, wherein the separable window correlation calculations comprise:
obtaining, using the processor incorporating the at least one tensor processing core, one-dimensional discrete Fourier transforms (DFTs) of columns and rows of a window in a first image using a real DFT matrix;
obtaining, using the processor incorporating the at least one tensor processing core, one-dimensional DFTs of columns and rows of a corresponding window in a second image using the real DFT matrix;
reconstructing, using the processor incorporating the at least one tensor processing core, complex Fourier space values for the 2D discrete Fourier transform from outputs obtained using the real DFT matrices;
performing, using the processor incorporating the at least one tensor processing core, elementwise multiply-conjugate operations with respect to the reconstructed complex Fourier space values;
converting, using the processor incorporating the at least one tensor processing core, complex products to real values to obtain a real value matrix;
obtaining, using the processor incorporating the at least one tensor processing core, one-dimensional inverse discrete Fourier transforms (IDFTs) of rows and columns of the real value matrix; and
determining, using the processor incorporating the at least one tensor processing core, subpixel peaks based upon output of the one-dimensional IDFTs; and
outputting, using the processor, optical flow information for the input images.

12. The method of claim 11, wherein obtaining the one-dimensional discrete Fourier transforms using the first real DFT matrix comprises:
expanding a complex Discrete Fourier Transform matrix into an expanded matrix;
removing redundant rows from the expanded matrix; and
scaling DC and Nyquist rows of the resulting matrix to generate the real DFT matrix.

13. The method of claim 12, wherein the first real DFT matrix R is defined by:
$${R}_{r , c} := \{ \begin{matrix}\frac{\sqrt{2}}{2} & if r = 0 \\ \frac{\sqrt{2}}{2} cos ( π c ) & if r = 1 \\ cos ( {α}_{⌊ r / 2 ⌋} c ) & if r \geq 2 and r is even \\ sin ( {α}_{⌊ r / 2 ⌋} c ) & if r \geq 3 and r is odd\end{matrix}$$
where αₖ represents a frequency component associated with each row.

14. The method of claim 11, wherein reconstructing complex Fourier space values from outputs obtained using the real DFT matrices comprises:
removing a DC×DC component;
handling top-left corner values;
processing top two rows and left two columns; and
reconstructing remaining complex values using 2×2 submatrices.

15. The method of claim 14, wherein reconstructing the remaining complex values comprises:
for a 2×2 submatrix with top-left corner (u,v), calculating:
$${F}_{u / 2 , v / 2} = ( {S}_{u , v} - {S}_{u + 1 , v + 1} ) + i ( {S}_{u , v + 1} + {S}_{u + 1 , v} )$$
$${F}_{W - u / 2 , v / 2} = ( {S}_{u , v} + {S}_{u + 1 , v + 1} ) + i ( {S}_{u , v + 1} - {S}_{u + 1 , v} )$$
where F represents complex Fourier space values for the 2D discrete Fourier transform, S represents outputs of the real Discrete Fourier Transform matrices, and W is the window size.

16. The method of claim 11, further comprising accelerating an ArgMax calculation by:
bit-casting float16 values to int16 format;
packing maximum values and their indices into single 32-bit integers;
performing a warp-wide int32 max reduction; and
extracting a maximum value and its index from the reduction result.

17. The method of claim 16, wherein accelerating the ArgMax calculation further comprises:
comparing float16 values with zero and bit-casting the maximum to int16 format;
left-shifting the bit-cast value by 16 bits and combining it with an index;
applying a warp-wide int32 max function to the combined value; and
extracting a maximum value and its index from the reduction result using bit masking and shifting operations.

18. The method of claim 11, further comprising accelerating matrix transposition by:
executing a nested loop structure in parallel across GPU threads;
determining a permutation index for each value in a first matrix (C); and
reassigning values to a matrix transpose (B^{T}) based on the determined permutation indices.

19. The method of claim 18, wherein determining the permutation index comprises calculating:
$${L}_{{B}^{T}}^{- 1} ( {L}_{C} ( t , v ) )$$
where L_{C} and L_{B}_{^{T}} are layout functions that define how register indices map to positions in the full matrices C and B^{T}, respectively, tis a thread index, and v is a value index within the thread.

20. The method of claim 11, wherein the windows in the input images are 32 pixels by 32 pixels.
